(19) United States
(12) Patent Application Publication
(10) Pub. No.: US 2001/0023762 A1
(43) Pub. Date: Sep. 27, 2001

(54) Heat pipe spreader construction

(76) Inventor: E. Mikhail Sagal, Watertown, MA (US)

Correspondence Address: BARLOW, JOSEPHS & HOLMES, LTD., 101 DYER STREET, 5TH FLOOR, PROVIDENCE, RI, 02903, US

(21) Appl. No.: 09/757,541

(22) Filed: Jan. 10, 2001

Related U.S. Application Data
(60) Provisional application No. 60/175,499, filed on Jan. 11, 2000.

(51) Int. Cl. F28D 15/00; F28F 7/00; B23P 6/00

(52) U.S. Cl. 165/185; 165/104.21; 29/890.032

(57) ABSTRACT

A heat pipe spreader construction includes a heat pipe with phase change media therein with a top plate and a bottom plate positioned in thermal communication with the heat pipe. A thermally conductive composition is molded about the heat pipe and between the top plate and the bottom plate to embrace and contain the heat pipe therein to form an improved net shape moldable heat spreader construction.

### BACKGROUND OF THE INVENTION

The present invention relates generally to the cooling of heat generating surfaces and objects. More specifically, the present invention relates to apparatuses for dissipating heat generated by such objects. In addition, the present invention relates to cooling of heat generating objects by use of composite materials, phase change devices and apparatus without the use of external fans to assist in cooling.

In industry, there are various parts and components that generate heat during operation. For example, in the electronics and computer industries, it is well known that computer components generate heat during operation. Various types of electronic device packages and integrated circuit chips, such as the PENTIUM central processing unit chip (CPU) manufactured by Intel Corporation and RAM (random access memory) chips and electromagnetic interference (EMI) shields are such devices that generate heat. These devices, particularly the CPU microprocessor chips, generate a great deal of heat during operation which must be removed to prevent adverse effects on operation of the system into which the device is installed. For example, a PENTIUM microprocessor, containing millions of transistors, is highly susceptible to overheating which could destroy the microprocessor device itself or other components proximal to the microprocessor.

There are a number of prior art methods to cool heat generating components and objects to avoid device failure and overheating, as discussed above. A block heat sink or heat spreader is commonly placed into communication with the heat generating surface of the object to dissipate the heat therefrom. Such a heat sink typically includes a base member with a number of individual cooling members, such as fins, posts or pins, to assist in the dissipation of heat. The geometry of the cooling members is designed to improve the surface area of the heat sink with the ambient air for optimal heat dissipation. The use of such fins, posts of pins in an optimal geometrical configuration greatly enhances heat dissipation compared to devices with no such additional cooling members, such as a flat heat spreader.

It is also known to employ heat pipes to improve the overall performance of a heat spreader or heat sink. A heat pipe is typically a closed ended tubular metal body that is charged with a phase change media, such as water or ammonia. One end of the heat pipe is placed in communication with a heat generating object while the opposing end is placed in a heat dissipating zone, such as exterior to a computer case or proximal to a fan assembly. The heat generating object heats up the phase change media within the heat pipe to a vapor state. The heated media then naturally migrates toward a cooler region of the heat pipe, namely the end opposite to that affixed to the heat generating object. As a result, the media within the pipe transfers heat from one point to another.

In the prior art, the construction of these heat pipes are very well know. However, due to their delicate tubular construction it is difficult to efficiently interface them with the heat generating object to be cooled, particularly where the heat generating object has a flat heat generating surface while the heat pipe is generally tubular in construction. To address this problem, it has been know for a flat interface plate to be soldered directly to the heat pipe where the flat interface plate communicates directly with the flat surface of the object to be cooled. However, soldering is expensive and time consuming and is not suitable for mass production.

To further enhance air flow and resultant heat dissipation, active cooling in the form of electric fans have been used, either internally or externally. However, these external devices consume power and have numerous moving parts. As a result, heat sink assemblies with active devices are subject to failure and are much less reliable than a device which is solely passive in nature.

It has been discovered that more efficient cooling of electronics can be obtained through the use of passive devices which require no external power source and contain no moving parts. It is very common in the electronics industry to have many electronic devices on a single circuit board, such as a motherboard, EMI shield, modem, or “processor card” such as the Celeron board manufactured by Intel Corporation. For example, EMI shields are susceptible to generating heat due to their proximity to heat generating components and need efficient and effective cooling as do the CPUs discussed above.

There have been prior art attempts to provide effective and efficient cooling to EMI shields, processors, and the like. The devices of the prior art are simply the technology previously used for CPUs and other heat generating components and structures. In particular, machined block heat sinks of metal have been typically used for cooling CPU chip, such as the Pentium processor, as described above. These block heat sinks have been modified in size to match the size of the chip on the video card to be cooled. Since the prior art heat sink is made of metal, it must be machined to achieve the desired fin configuration. Since the machining process is limited, the geometry of the fin configuration of a machined heat sink is inherently limited.

In the heat sink industries, it has been well known to employ metallic materials for thermal conductivity applications, such as heat dissipation for cooling semiconductor device packages. For these applications, such as heat sinks, the metallic material typically is tooled or machined from bulk metals into the desired configuration. However, such metallic conductive articles are typically very heavy, costly to machine and are susceptible to corrosion. Further, the geometries of machined metallic heat dissipating articles are very limited to the inherent limitations associated with the machining or tooling process. As a result, the requirement of use of metallic materials which are machined into the desired form, place severe limitations on heat sink design particular when it is known that certain geometries, simply by virtue of their design, would realize better efficiency but are not attainable due to the limitations in machining metallic articles.

In view of the foregoing, there is a demand for a heat spreader construction that is capable of dissipating heat. There is a demand for a heat spreader construction with no moving parts that can provide heat dissipation without the use of active components. In addition, there is a demand for a complete heat spreader construction that can provide greatly enhanced heat dissipation over prior art passive devices with an improved heat spreader construction. There is a demand for a heat spreader construction that can provide heat dissipation in a low profile configuration. There is a further demand for a net-shape molded heat spreader construction that is well suited for cooling heat generating components, such as EMI shields and microprocessors.

### SUMMARY OF THE INVENTION

The present invention preserves the advantages of prior art heat dissipation devices, heat exchangers and heat spreaders. In addition, it provides new advantages not found in currently available devices and overcomes many disadvantages of such currently available devices.

The invention is generally directed to the novel and unique heat spreader construction that is net-shape molded of a thermally conductive polymer composition. The present invention relates to a molded heat spreader for dissipating heat from a heat generating source, such as a computer semiconductor chip, electromagnetic interference (EMI) shield, or other electronic components.

The heat pipe spreader construction of the present invention has many advantages over prior art heat pipe constructions in that additional heat dissipating structure can be employed to enhance the overall thermal conductive and performance of the heat pipe. The heat pipe spreader construction of the present invention includes a heat pipe with phase change media therein with a top plate and a bottom plate positioned in thermal communication with the heat pipe. A thermally conductive composition is molded about the heat pipe and between the top plate and the bottom plate to embrace and contain the heat pipe therein to form an improved net shape moldable heat spreader construction.

Further, since the molded heat exchanger is injection molded, there is tremendous flexibility in the arrangement of the all components over the known soldering methods of interconnecting components as in prior art assemblies.

A single heat pipe is preferably employed but multiple heat pipes may be embedded within the construction of the present invention. The top plate and bottom plate are thermally interconnected to the heat pipe by overmolding a thermally conductive polymer material which achieves greatly improved results and its far less expensive than soldering a heat pipe to a heat spreader.

It is therefore an object of the present invention to provide an improved heat spreader construction that can provide enhanced heat dissipation for a heat generating component or object.

It is an object of the present invention to provide a heat spreader construction that can provide heat dissipation for semiconductor devices on a circuit board, such as a motherboard or video card.

It is a further object of the present invention to provide a heat spreader construction device that has no moving parts.

Another object of the present invention is to provide a heat spreader construction device that is completely passive and does not consume power.

A further object of the present invention is to provide a heat spreader construction that inexpensive to manufacture.

Another object of the present invention is to provide a heat spreader construction device that has a thermal conductivity greater that conventional heat sink designs.

A further object of the present invention is to provide a heat spreader construction that is net-shape moldable and is easy to manufacture. Yet another objection of the present invention is to provide a molded heat spreader construction that has a low profile configuration without sacrificing thermal transfer efficiency.

### BRIEF DESCRIPTION OF THE DRAWINGS

The novel features which are characteristic of the present invention are set forth in the appended claims. However, the inventions preferred embodiments, together with further objects and attendant advantages, will be best understood by reference to the following detailed description taken in connection with the accompanying drawings in which:

FIG. 1 is a perspective view of the heat pipe spreader construction of the present invention; and

FIG. 2 is a cross-sectional view through the line 2-2 of FIG. 1.

### DETAILED DESCRIPTION OF THE PREFERRED EMBODIMENT

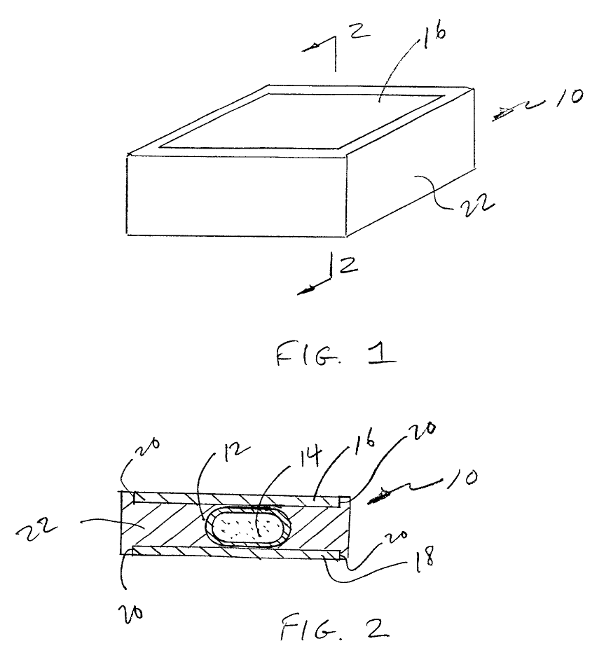

Referring to FIGS. 1 and 2, the heat pipe spreader construction 10 of the present invention is shown. The construction 10 includes a heat pipe 12, with phase change media 14 therein, that provides a centrally positioned heat transfer member that is sandwiched between a top plate 16 and a bottom plate 18. The top plate 16 and the bottom plate 18 are manufactured of a thermally conductive material and is, preferably, a metallic material, such as aluminum or copper. The top plate 16 and bottom plate 18 are preferably flat to facilitate flush thermal communication with a heat generating surface of a heat generating object, such as a EMI shield or microprocessor.

Overmolded around and between the top plate 16, heat pipe 12 and bottom plate 18 is moldable thermally conductive material, such as a thermally conductive polymer composite material. Preferably, the composite material is molded around the heat pipe 12 and the top plate 16 and bottom plate 18 and therebetween to provide a unitary net-shape molded heat spreader configuration 10. As best seen in FIG. 2, the polymer composite material 22 is molded between the top plate 16 and the bottom plate 18 but may also be molded over the outer edges 20 of the top plate 16 and the bottom plate 18 to assist in retaining the construction in a unitary heat spreader configuration 10.

The thermally conductive material 22 is preferably a conductive polymer composition that includes a base polymer of, for example, a liquid crystal polymer that is loaded with a conductive filler material, such as copper flakes or carbon fiber. Other base materials and conductive fillers may be used and still be within the scope of the present invention. Also, the heat spreader construction 10 of the present invention is net-shape molded which means that after molding it is ready for use and does not require additional machining or tooling to achieve the desire configuration of the spreader part 10. With the assistance of the heat pipe 12 and the overmolded thermally conductive composition, the present invention provides an improved heat spreader where the heat is spread more evenly and effectively through the body of the heat spreader construction 10.

A described above, the ability to injection mold a thermally conductive device rather than machine it has many advantages. Although not shown, additional fins or pins may be integrally molded into the side of the heat spreader construction 10 of thermally conductive material to further enhance cooling and heat dissipation of the construction.

The heat pipe spreader 10 of the present invention may be affixed to a surface to be cooled in a fashion similar to the way a conventional heat spreader is affixed to a surface to be cooled. The bottom plate 16 is mated with the surface to be cooled while the top plate 18 is optionally mated with additional heat dissipating devices, such as a heat sink with a pin grid array. The construction 10 may be positioned between the component to be cooled and a cover of a computer, such as the cover of a laptop computer to enable dissipation of heat from the heat generating object through the case of the laptop computer (not shown). Further, fasteners (not shown), such as threaded screws, may be provided to secure the heat spreader to a surface. The heat spreader may be affixed to a surface with thermally conductive adhesive. Other different types of fasteners and connection methods may be employed for this purpose, such as spring clips and clamps.

It should be understood that the application shown in FIGS. 1 and 2 is merely an example of the many different applications of the present invention and is for illustration purposes only. The heat spreader of the present invention is shown in a square configuration; however, an configuration may be employed to suit the application and device environment at hand, such as Z-shaped or meandering configuration.

It would be appreciated by those skilled in the art that various changes and modifications can be made to the illustrated embodiments without departing from the spirit of the present invention. All such modifications and changes are intended to be covered by the appended claims.

What is claimed is:

1. A net-shape molded heat spreader construction, comprising:
a heat pipe charged with phase change media having a top surface and a bottom surface;
a top plate positioned in thermal communication with said top surface of said heat pipe;
a bottom plate positioned in thermal communication with said bottom surface of said heat pipe; and
thermally conductive moldable composition positioned about said heat pipe and between said top plate and said bottom plate.

2. The net-shape molded heat spreader construction of claim 1, wherein said thermally conductive moldable composition is a polymer composite material loaded with thermally conductive filler.

3. The net-shape molded heat spreader construction of claim 1, wherein said polymer composite material is a liquid crystal polymer.

4. The net-shape molded heat spreader construction of claim 1, wherein said thermally conductive filler is carbon fiber.

5. The net-shape molded heat spreader construction of claim 1, wherein said thermally conductive filler is copper flakes.

6. The net-shape molded heat spreader construction of claim 1, wherein said thermally conductive filler is boron nitride grains.

7. The net-shape molded heat spreader construction of claim 1, wherein said thermally conductive filler is aluminum flakes.

8. A method of forming a net-shape molded heat spreader construction, comprising the steps of:
providing a heat pipe charged with phase change media having a top surface and a bottom surface;
positioning a top thermally conductive plate in thermal communication with said top surface of said heat pipe;
positioning a bottom thermally conductive plate in thermal communication with said bottom surface of said heat pipe; and
molding a thermally conductive composition about said heat pipe and between said top thermally conductive plate and said bottom thermally conductive plate.

9. The method of claim 8, wherein the step of molding a thermally conductive composition comprises molding a thermally conductive polymer composition.

10. The method of claim 8, wherein the step of molding a thermally conductive composition comprises molding a thermally conductive liquid crystal polymer composition.
